(19) United States
(12) Patent Application Publication
(10) Pub. No.: US 2008/0084582 A1
(43) Pub. Date: Apr. 10, 2008

(54) COMPLEX MACHINE AND PRINTING SYSTEM

(75) Inventor: Osamu AZAMI, Suwa-shi (JP)

Correspondence Address: SUGHRUE-265550, 2100 PENNSYLVANIA AVE. NW, WASHINGTON, DC, 20037-3213, US

(73) Assignee: SEIKO EPSON CORPORATION, Tokyo (JP)

(21) Appl. No.: 11/867,069

(22) Filed: Oct. 4, 2007

(30) Foreign Application Priority Data
Oct. 6, 2006 (JP) 2006-275181

(51) Int. Cl. G06K 15/00

(52) U.S. Cl. 358/1.18; 358/453

(57) ABSTRACT

A complex machine includes: a scanning unit having a function of scanning an object put on a platen to thereby generate image data of the object; a printing unit that performs printing on a sheet; a control unit that, when designation-information-included printing data including region designation information that designates a region on the sheet, scanning region designation information that designates a scanning region, and printing data that defines an image to be printed onto the sheet is received, makes the scanning unit scan a range based on the scanning region designation information to thereby acquire the image data, and that makes the printing unit print on the sheet the image indicated by the printing data and a scanning image that is an image indicated by the acquired image data so that the scanning image is positioned within the region indicated by the region designation information.

### BACKGROUND

1. Technical Field

The present invention relates to a complex machine, and a printing system including the complex machine and a printing data generator.

2. Related Art

Recent general document generating system are adapted to be capable of simply printing papers (papers on which an image indicated by the image data has been printed together with a document) in which the image data is embedded, if image data is prepared.

However, it is troublesome to prepare image data (operate a scanner/complex machine) purposely for papers that are printed only once (document requiring embedding of image data). Further, some papers (for example, papers attaching a copied driver's license prepared in the bank etc.) include an image that is not preferably changed into image data together with the documents.

### SUMMARY

An advantage of some aspects of the invention is to provide a complex machine and a printing system, capable of simply performing printing of papers that require embedding of image data and that are printed only once, or papers that includes an image that is not preferably changed into image data together with the documents.

The advantage can be attained by at least one of the following aspects:

An aspect of the invention provides a complex machine comprising: a scanning unit having a function of scanning an object put on a platen to thereby generate image data of the object; a printing unit that performs printing on a sheet; a control unit that, when designation-information-included printing data including region designation information that designates a region on the sheet, scanning region designation information that designates a scanning region, and printing data that defines an image to be printed onto the sheet is received, makes the scanning unit scan a range based on the scanning region designation information to thereby acquire the image data, and that makes the printing unit print on the sheet the image indicated by the printing data and a scanning image that is an image indicated by the acquired image data so that the scanning image is positioned within the region indicated by the region designation information.

That is, the complex machine of the invention is an apparatus that is capable of obtaining printing results including the printing data indicated by the printing data included in the designation-information-included printing data and an image relating to an object to be scanned, if a thing which includes an image to be printed together with the document (hereinafter referred to as “an object to be scanned”) is put in a specific position on a platen (position according to the scanning region designation information), and then, the designation-information-included printing data is transmitted. Accordingly, if this complex machine is installed in an office together with an apparatus capable of generating the designation-information-included printing data (if the printing system of the invention is installed in an office, etc.), it is possible to realize a work environment capable of simply performing printing of papers that require embedding of image data and that are printed only once, or papers that includes an image that is not preferably changed into image data together with the documents.

In addition, the complex machine of the invention may be realized as an apparatus in which any types or contents of information are used as region designation information or scanning region designation information. For example, the complex machine of the invention can be realized as an apparatus in which the information that designates a region indicated by a distance from one side of a printable range of the printing unit is used as the region designation information.

### BRIEF DESCRIPTION OF THE DRAWINGS

The invention will be described with reference to the accompanying drawings, wherein like numbers reference like elements.

FIG. 1 is a block diagram of a printing system according to a first embodiment of the invention.

FIG. 2 is an explanatory view of a printing setting dialogue box that is displayed by a printer driver according to the embodiment.

FIG. 3 is a flow chart of the processing to be executed when the complex machine (control unit in the complex machine) according to the embodiment has received the printing data including image-embedded printing instruction information.

FIG. 4 is an explanatory view of an application of the printing system according to the embodiment.

FIG. 5 is an explanatory view of printing results in a case where the printing system according to the embodiment is utilized in a way as shown in FIG. 4.

### DESCRIPTION OF EXEMPLARY EMBODIMENTS

Hereinafter, an exemplary embodiment of the invention will be described in detail with reference to the accompanying drawings.

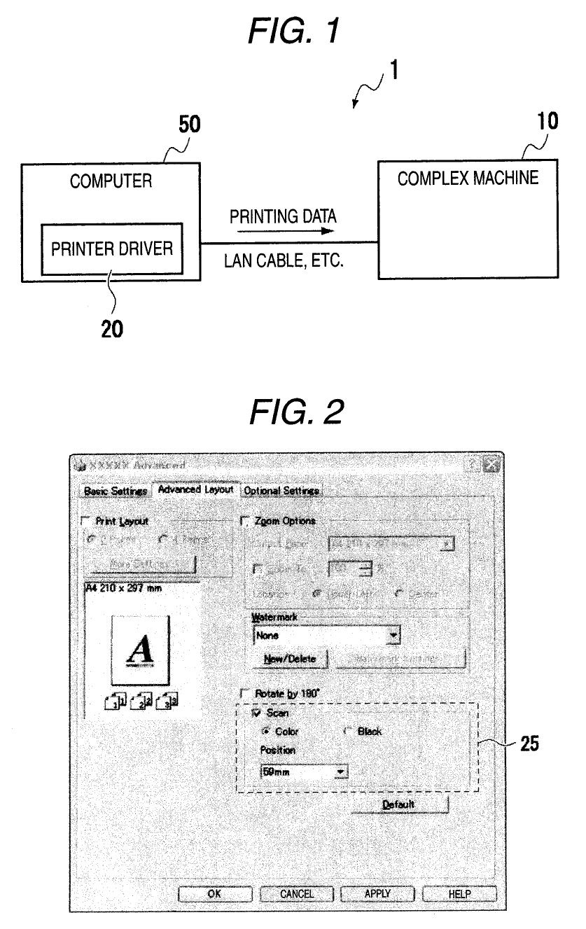

As shown in FIG. 1, a printing system 1 according to one embodiment of the invention is a system that is constituted by a complex machine 10, and any number of (one in the drawing) computer 50 in which a printer driver 20 is installed.

The complex machine 10 used for this printing system 1 is an apparatus that operates as a color copying machine, a network scanner, a network printer, or the like. In addition, although description of a specific hardware configuration is omitted, the complex machine 10, similarly to general complex machines, is an apparatus that are constituted by a scanning unit that scans an object (or an original) on a platen to generate of image data, a printing unit (a unit made up of a CPU, an ASIC, a network interface circuit and a parallel interface circuit for performing communication with the computer 50, and the like) that performs color/monochrome printing on a sheet, and a control unit that controls the scanning unit and the printing unit.

The printer driver 20 is a program that generates the printing data for the complex machine 10 to transmit the data to the complex machine 10

This printer driver 20 is a program obtained by improving an existing printer driver (a printer driver capable of specifying whether color printing will be performed or monochrome printing will be performed) so as for a user to issue an instruction of executing image-embedded printing, and so as to generate and transmit printing data (data obtained by adding image-embedded instruction information data to normal printing data) including only image-embedded printing instruction information, if an instruction of executing image-embedded printing is issued by a user.

Specifically, the printer driver 20 is a driver that displays a printing setting dialogue box shown in FIG. 2. In addition, each of the items displayed in a broken-line frame 25 on this printing setting dialogue box is an item added so as for a user to issue an instruction of executing image-embedded printing.

The printer driver 20 is a program that functions as a printer driver having the same function as the existing driver if a “Scan” checkbox is not checked, and that functions as a printer driver that generates and transmits printing data including, as image-embedded printing instruction information, information (actually, a command group for control of a scanner) including a scanning mode designation value indicating whether either “Color” or “Black” is turned on, and a value set in a “Position” textbox (corresponding to region designation information, and scanning region designation information; hereinafter marked as region designation value).

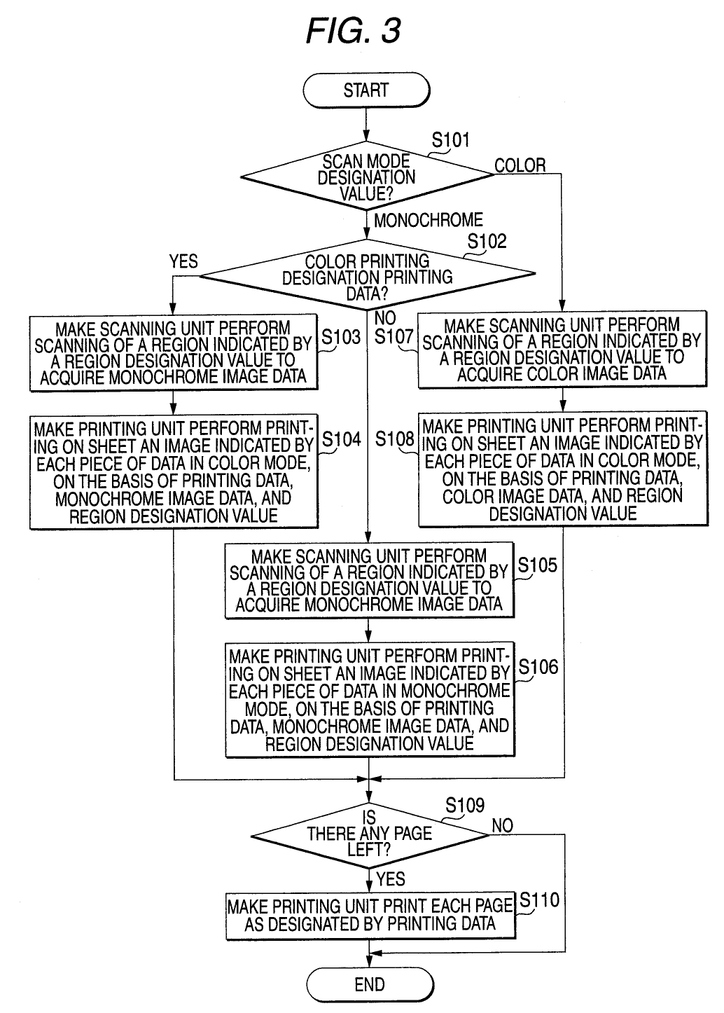

On the other hand, the complex machine 10 is an apparatus obtained by adding to an existing complex machine (control unit) “the function to execute processing of the procedure shown in FIG. 3 at the time of reception of printing data including image-embedded printing instruction information.”

That is, if the control unit of the complex machine 10 has received the printing data including image-embedded printing instruction information, first, the control unit determines whether or not the scanning mode designation value in the image-embedded printing instruction information in the printing data is a value indicating that color scanning is performed (that the “Color” radio button is turned on, or a value indicating that monochrome scanning is performed (that the “Black” radio button is turned on) (Step S101).

If the scanning mode value is a value indicating that monochrome is performed (Step S101: monochrome), the control unit determines whether or not presently received printing data is data in which color printing is designated or data in which monochrome printing is designated (S102).

Then, if the printing data is the data in which color printing is designated (Step S102: YES), the control unit makes the scanner unit perform scanning (in the drawing, scanning of a region indicated by a region designation value) a region indicated by a region designation value in a sub-scanning direction from a normal scanning start position, thereby performing the processing of acquiring monochrome image data about a scanned portion (Step S103). Next, the control unit performs the processing (Step S104) of making the printing unit print “a sheet on which an image indicated by each piece of data has been printed in a color mode, and on which an image indicated by monochrome image data has been printed in a region having a length indicated by the region designation value from a lower end of a printable region”, on the basis of the acquired monochrome image data, the presently received printing data (a portion excluding the image-embedded printing instruction information), and the region designation value.

Then, if any page to be printed is not left (Step S109: NO), the control unit completes the processing of this drawing, and if a page to be printed is left (Step S109: YES), the control unit makes the printing unit print each page as designated by printing data (in such a form that embedding of an image is not performed) (Step S110), and then completes the processing of this drawing.

Further, if the printing data is data in which monochrome printing is designated (Step S102: NO), the control unit performs the processing of the same content as the processing of Step S103 as described above. Then, the control unit performs the processing (Step S106) of making the printing unit print “a sheet on which an image indicated by each piece of data has been printed in a monochrome mode and on which an image indicated by monochrome image data has been printed in a region having a length corresponding to a region designation value from a lower end of a printable region”, on the basis of the acquired monochrome image data, the presently received printing data, and the region designation value. Thereafter, the control unit performs the processing of Step S110 if necessary (Step S109: YES), and then completes the processing of this drawing.

Further, if the scanning mode designation value is a value indicating that color scanning is performed (Step S101: color), the control unit makes the scanning unit perform scanning a region corresponding to a region designation value from a normal scanning start position, thereby performing the processing of acquiring color image data about a scanned portion. Next, the control unit performs the processing (Step S108) of making the printing unit print “a sheet on which an image indicated by each piece of data has been printed in a color mode, and on which an image indicated by color image data has been printed in a region having a length corresponding to a region designation value from a lower end of a printable region”, on the basis of the acquired color image data, the presently received printing data, and the region designation value. Then, the control unit performs the processing of Step S110 if necessary (Step S110: YES), and then completes the processing of this drawing.

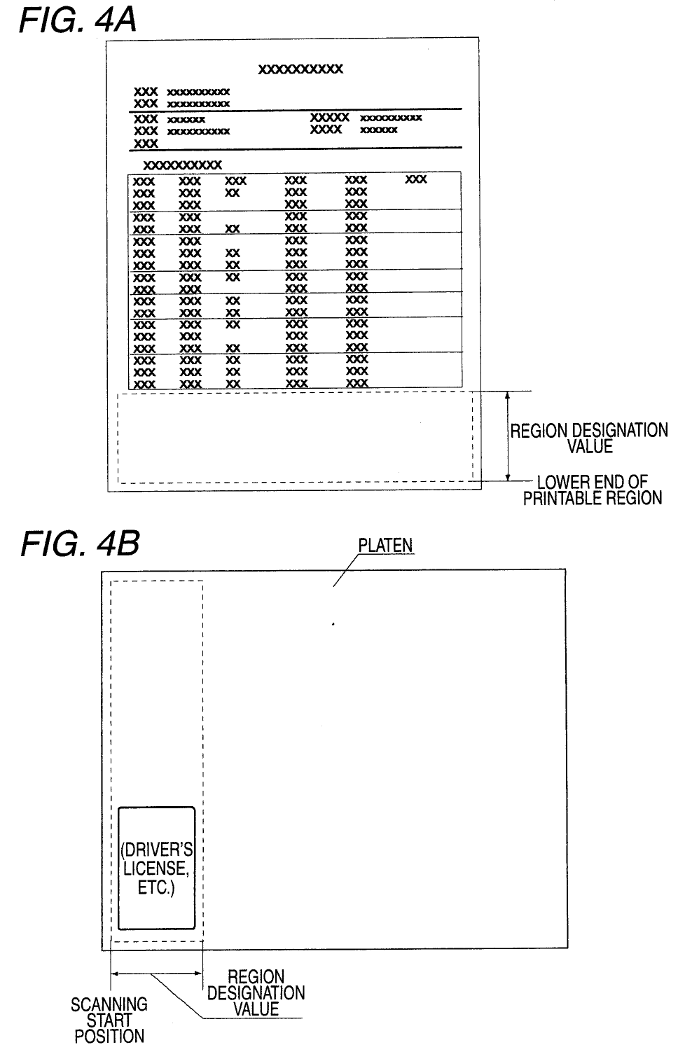

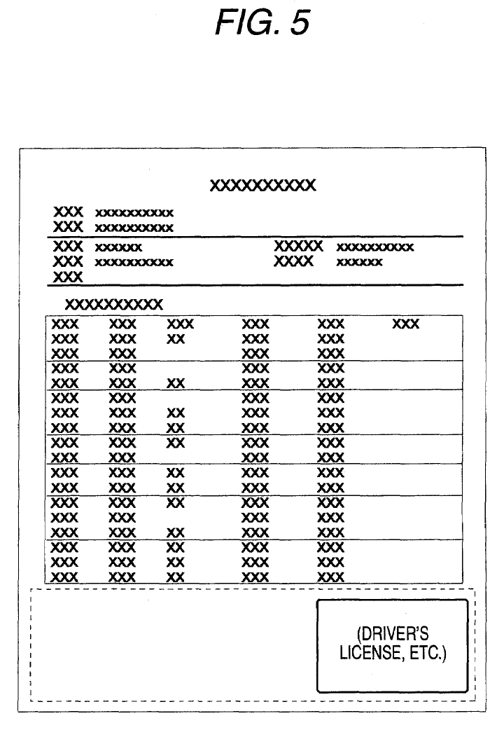

As apparent from the above description, the printing system 1 according to the present embodiment is a system that can utilize document creating software of the computer 50 to create document data of the contents as shown in FIG. 4A (document data including at its lower end a region in which letters, etc. are not printed in a length in the height direction that coincides with a region designation value), and that, by putting an object to be scanned (a thing which includes an image to be printed together with the document; a driver's license in the drawing) on a platen in such as manner as shown in FIG. 4B and then making the complex machine 10 perform printing of the created document data, can obtain a print as shown in FIG. 5.

Accordingly, if this printing system 1 is installed in an office, it is possible to realize a work environment capable of simply performing printing of papers that require embedding of image data which are printed only once, or papers that includes an image that is not preferably changed into image data together with the documents.

### Modified Example

The above-described printing system 1 can be modified in various ways. For example, the complex machine 10 and the printer driver 20 can be modified into those that can set the side or position of a region on a sheet on which a scanning image is arranged in details. Further, the document creating software on the computer 50 can also be software capable of performing an instruction of image-embedded printing. Moreover, the complex machine 10 can also be modified into an apparatus that has a function to convert image-embedded printing data into an electronic file to store the file therein (on a hard disk in the apparatus itself), or to transmit the file to a PC or a server. Further, it is natural that an apparatus to be connected to the complex machine 10 may be other apparatuses (exclusive apparatuses for the purpose of specific work) than the computer 50.

This application claims priority from Japanese Patent Application No. 2006-275181 filed on Oct. 6, 2006, the entire disclosure of which is expressly incorporated by reference herein.

While this invention has been described in conjunction with the specific embodiments thereof, it is evident that many alternatives, modifications, and variations will be apparent to those skilled in the art. Accordingly, preferred embodiments of the invention as set forth herein are intended to be illustrative, not limiting. There are changes that may be made without departing from the spirit and scope of the invention.

What is claimed is:

1. A complex machine comprising:
a scanning unit having a function of scanning an object put on a platen to thereby generate image data of the object;
a printing unit that performs printing on a sheet;
a control unit that, when designation-information-included printing data including region designation information that designates a region on the sheet, scanning region designation information that designates a scanning region, and printing data that defines an image to be printed onto the sheet is received, makes the scanning unit scan a range based on the scanning region designation information to thereby acquire the image data, and that makes the printing unit print on the sheet the image indicated by the printing data and a scanning image that is an image indicated by the acquired image data so that the scanning image is positioned within the region indicated by the region designation information.

2. The complex machine according to claim 1,
wherein the region designation information is information that designates the region indicated by a distance from one side of a printable region of the printing unit.

3. A printing system comprising a complex machine and a printing data generator,
wherein the printing data generator includes:
an information acquiring unit that acquires from a user region designation information that designates a region on a sheet, and scanning region designation information that designates a scanning region; and
a designation-information-included printing data transmitting unit that transmits designation-information-included printing data including the region designation information and the scanning region designation information acquired by the information acquiring unit, and printing data that defines an image to be printed onto the sheet, to the complex machine,
wherein the complex machine includes:
a scanning unit having a function of scanning an object put on a platen to thereby generate image data of the object;
a printing unit that performs printing on the sheet;
a control unit that, when the designation-information-included printing data is received, makes the scanning unit scan a range indicated by the scanning region designation information, to thereby acquire image data, and that makes the printing unit print on the sheet the image indicated by the printing data and a scanning image that is an image indicated by the acquired image data so that the scanning image is positioned within the region indicated by the region designation information.
